(19) United States
(12) Patent Application Publication
(10) Pub. No.: US 2016/0064883 A1
(43) Pub. Date: Mar. 3, 2016

(54) Electrical Power Cord with Supplemental Socket

(71) Applicant: Tom Macauda, Downers Grove, IL (US)

(72) Inventor: Tom Macauda, Downers Grove, IL (US)

(21) Appl. No.: 14/839,615

(22) Filed: Aug. 28, 2015

Related U.S. Application Data
(60) Provisional application No. 62/042,939, filed on Aug. 28, 2014.

(51) Int. Cl. H01R 27/02; H01R 13/52; H01R 13/713

(52) U.S. Cl. CPC H01R 27/02; H01R 13/7135; H01R 13/5202

(57) ABSTRACT

A power cord with an integrated socket box located between its plug and connector has many advantages, especially in the construction industry. Power tools can be manufactured with this power cord so that one need not look for an extension cord when he is seeking to use a secondary tool. This power cord also allows for multiple parties to work from a single power source.

In some embodiments the power tool is an integral part of the electrical device, such as a power tool. In other embodiments, the power cord is permanently attached to the existing electrical device. In some cases a securing sheathe made of heat shrinking tubing is used to attach the power cord to the electrical device.

In some embodiments the integrated socket box can have more than one socket. In at least one embodiment the integrated socket box has a ground fault interrupter.

### CROSS-REFERENCE TO RELATED APPLICATIONS

This application is related to and claims priority from U.S. Provisional Application No. 62/042,939 filed Aug. 28, 2014 entitled “Electrical Power Cord With Supplemental Socket.” The '939 application is hereby incorporated by reference in its entirety.

### FIELD OF THE INVENTION

The present disclosure relates to electrical power cords and, more specifically, power cords, cord sets and extension cords with one or more power sockets.

### BACKGROUND OF THE INVENTION

A power cord is an electrical cable used to connect an electrical device or appliance to a source of electrical power such as a mains electricity supply outlet or an extension cord connected to a mains outlet.

In one case, a power cord comprises a length of flexible electrical power cable, a male connector (or plug) at one end, and a female connector (socket, port or outlet) at the other end.

A power cord comprising an integrated connector at each end, one male and one female, is typically known as a cord set. Cord sets are usually detachable from the power supply and the device.

In another case, a power cord for a device has a length of flexible electrical power cable and a male connector at one end, with the other end electrically connected directly to the device. In this case, the power cable can be conjoined with the device, or at least securely fastened to the device, and is not intended be detached by a user.

An extension cord is a convenient way to provide power to an electrical device or appliance located a distance way from a suitable power outlet or source of electrical power. Like a power cord, an extension cord typically has a length of flexible electrical power cable, a male connector (or plug) at one end, and a female connector (socket, port or outlet) at the other end.

Generally, the plug and the socket are of the same type of connector, the plug connects to a mains outlet and the socket mates with a plug attached to the electrical device.

Extension cords can be used in household applications, for example to provide power to a lamp, an electronic device or a household appliance. Extension cords can also be used in construction environments and industrial applications, for example to provide power to a power tool. Extension cords can be used in indoor and outdoor situations.

The power cable in a power cord or an extension cord has a number of wires, each wire with a suitable gauge. The number of wires and the gauge of each wire is determined, at least in part, by the distance along the cable from the plug to the socket, and by the maximum electrical current to be carried by the cable.

Electrical devices such as power tools can have supplemental sockets on the body of the devices. One disadvantage is that work being done by the first device (for example a power tool) can interfere with work being done (sometimes by a different operator) by a second device connected to the supplemental socket.

Also, there is an increased risk of damage to an electrical cable supplying the second tool if it is connected to the supplemental socket on the body of the tool than if it is receiving power from a socket not located on the body of the tool.

There can also be practical limitations with locating a supplemental socket on the body of the tool, for example, size of the socket relative to the size of the tool, and heat dissipation.

### SUMMARY OF THE INVENTION

One often finds himself or herself in need of additional power outlets. While traditional power strips can be used in many instances, often it would be convenient if the electrical device currently occupying one of the main outlets, had its own socket box. This is especially true in the construction industry, in which workers are often switching between multiple power tools.

A power cord with an integrated socket box located between its plug and connector has many advantages. In some embodiments the power tool can be an integral part of an electrical device, such as a power tool. Power tools can be manufactured with this power cord so that one need not look for an extension cord when he is seeking to use a secondary tool. This power cord would allow for multiple parties to work from a single power source.

In other embodiments, the power cord can be permanently attached to an existing electrical device. This allows a user to retrofit older electronic devices. In some cases a securing sheathe made of heat shrinking tubing is used to attach the power cord to the electrical device, although other securing methods are possible.

A plug-in electrical device includes a main device; and a power cord, wherein the power cord has a plug, a socket box, and a length of electrical wire.

In some embodiments the main device is a power tool. In certain embodiments the main device is a circular saw. In other embodiments the main device is a router. In further embodiments the main device is an air-compressor.

In certain embodiments the plug is integrated into the main device. In other or the same embodiments the socket box is located along the length of electric wire between the main device and the plug.

In some embodiments the socket box includes a first socket. In other or the same embodiments the socket box includes a second socket. In other or the same embodiments the socket box includes a ground fault interrupter.

A power cord can include a plug, a length of electric wire, an end socket; and a socket box, wherein the socket box is located along the length of electric wire between the plug and the end socket.

In some embodiments the socket box includes a first socket. In other or the same embodiments the socket box includes a second socket. In other or the same embodiments the socket box includes a ground fault interrupter.

In some embodiments the power cord can include a securing sheathe wherein the sheathe is configured to secure the end socket to a second electrical plug. In some embodiments the second electrical plug is connected to a power tool. In certain embodiments the securing sheathe is a heat shrinking tubing. In other or the same embodiments the securing sheathe is waterproof

A power block includes a plug and a socket box, and magnet and a clip. In some embodiments the socket box can include a first socket, a second socket, a USB port, and/or a a ground fault interrupter.

### BRIEF DESCRIPTION OF THE DRAWINGS

FIG. 1 is a perspective view of a portable circular saw with an integrated multi-socket power cord.

FIG. 2 is a perspective view of a router with an integrated multi-socket power cord.

FIG. 3A is a front perspective view of a multi-socket extension cord.

FIG. 3B is a back perspective view of the multi-socket extension cord of FIG. 3A.

FIG. 4 is a perspective view of a multi-socket extension cord with an integrated ground fault interrupter (GFI).

FIG. 5 is a perspective view of a mechanism for securely conjoining two power cords or extension cords.

FIG. 6 is an exploded perspective view of a router with an integrated multi-socket power cord attached via the mechanism illustrated in FIG. 5.

FIG. 7A is a front perspective view of a multi-socket power block.

FIG. 7B is a back perspective view of a multi-socket power block of FIG. 7A.

### DETAILED DESCRIPTION OF PREFERRED EMBODIMENT(S)

The present apparatus relates to the supply of electrical power to one or more electrical devices or appliances.

The present apparatus is particularly suitable for situations where more than one device requires electrical power from the same mains outlet.

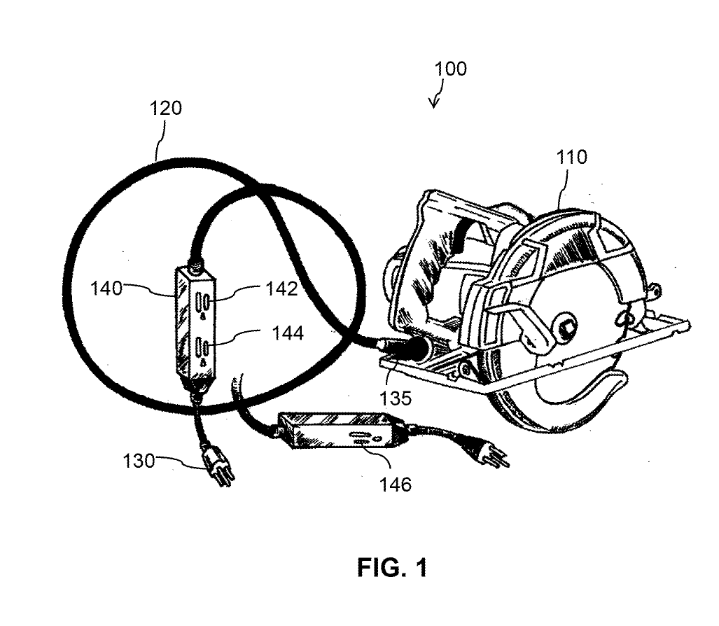

FIG. 1 is a perspective view of portable circular saw 100 with an integrated multi-socket power cord. Circular saw 100 comprises circular saw tool 110, power cable 120, plug 130 and connection 135.

Plug 130 and power cable 120 can be configured to work with a wide variety of voltages, including but not limited to 110 and 220 volts.

Circular saw 100 further has socket box 140 integrated into power cable 120. Socket box 140 can have one or more sockets such as sockets 142, 144 and 146 shown in FIG. 1.

Socket box 140 can be located at a suitable position along power cable 120. In the example embodiment shown in FIG. 1, socket box 140 is located close to plug 130. In other embodiments, socket box 140 can be located close to connection 135 and, in yet other embodiments, socket box 140 can be located at an intermediate position along power cable 120.

In some embodiments, two or more socket boxes 140 can be integrated into power cable 120, each socket box 140 comprising one or more sockets such as sockets 142, 144 and 146.

When plug 130 is connected to a mains power supply, sockets 142, 144 and 146 can be used to supply power to electrical devices.

A benefit of integrating power cable 120 and socket box 140 with circular saw tool 110 via connection 130 is that the one or more additional sockets (such as sockets 142, 144 and 146) are conveniently located and readily accessible to the operator of circular saw 100.

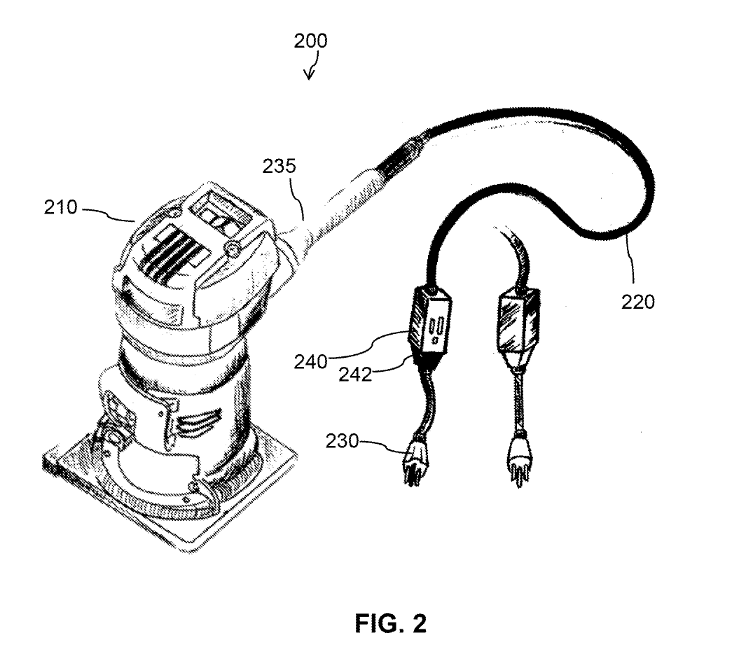

FIG. 2 is a perspective view of router 200 with an integrated multi-socket power cord. Router 200 has router tool 210, power cable 220, plug 230 and a connection 235.

In some embodiments, router 200 can have socket box 240 integrated into power cable 220. Socket box 240 can have one or more sockets such as socket 242 shown in FIG. 2. When plug 230 is connected to a mains power supply, socket 242 can be used to supply power to an electrical device.

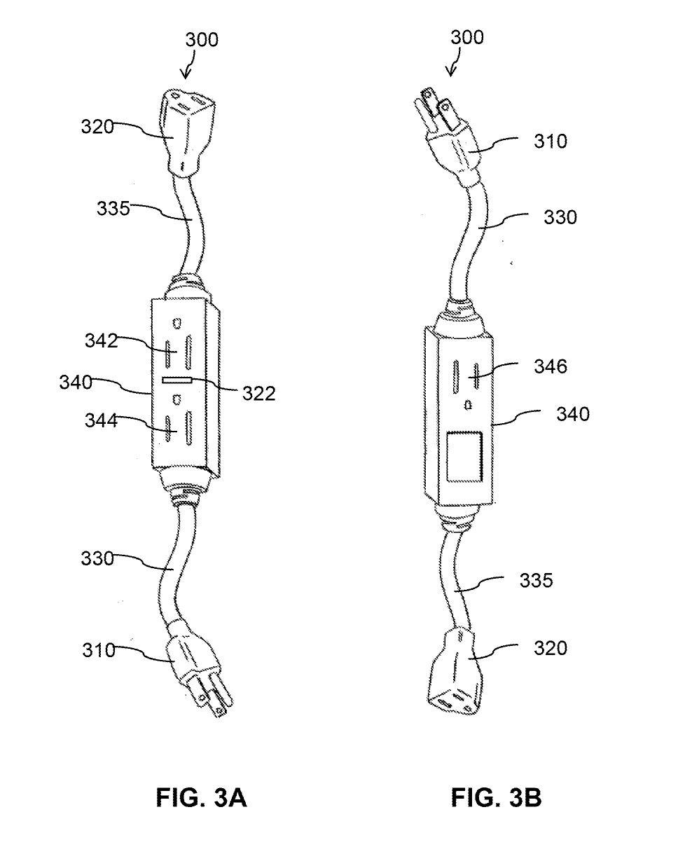

FIG. 3A is a front perspective view of multi-socket extension cord 300. FIG. 3B is a back perspective view of multi-socket extension cord 300 of FIG. 3A.

Multi-socket extension cord 300 has male connector (or plug) 310, female connector (or socket) 320, and socket box 340. A first length of power cable 330 connects plug 310 to socket box 340, and second length of power cable 335 connects socket 320 to socket box 340.

Socket box 340 can have one or more sockets such as sockets 342, 344 and 346 as shown in FIG. 3. When plug 310 is connected to a main power supply, sockets 320, 342, 344 and 346 can supply power to electrical devices.

In some embodiments, socket box 340 can include Universal Serial Bus (USB) port 322. USB port 322 allows for various electronics, such as many smartphones and tablets, to be charged and/or powered directly from extension cord 300 without the need of an adapter. USB port 322 can be one of any of the several standards including, but not limited to, USB 1.x, USB 2.0, USB 3.0, and any future standards.

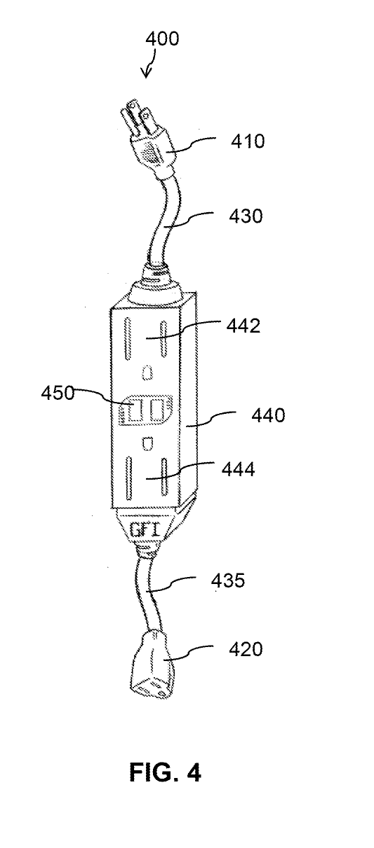

FIG. 4 is a perspective view of multi-socket extension cord 400 with an integrated ground fault interrupter (GFI).

Multi-socket extension cord 400 can have male connector (or plug) 410, female connector (or socket) 420, and socket box 440. First length of power cable 430 connects plug 410 to socket box 440, and second length of power cable 435 connects socket 420 to socket box 440.

In some embodiments, socket box 420 can light up to indicate that extension cord 400 is connected to an active power source. In other or the same embodiments, socket box 440 can include an indicia that indicates when extension cord 400 is connected to an active power source.

Socket box 440 can have one or more sockets such as sockets 442 and 444 as shown in FIG. 4. When plug 410 is connected to a main power supply, sockets 420, 442 and 444 can supply power to electrical devices.

In some embodiments, socket box 440 can have ground fault interrupter (GFI) 450. GFI 450 is desirable in situations such as when electrical devices powered via extension cord 400 are used in bathrooms or kitchens, outdoors, near swimming pools, or in connection with wet saws, wet-dry vacuums, and other power tools that are used with or near water. GFI 450 is configured to detect a leakage current of a few mA and trip a circuit breaker thereby reducing the risk of an electric shock to the user.

GFI 450 can comprise a “test” button and a “reset” button. When pressed, a “test” button simulates an electrical short by causing a small difference between the “hot” and “neutral” currents. If GFI 450 is working correctly, the test trips the circuit breaker. The breaker can be reset using the “reset” button.

A benefit of multi-socket extension cord 400 with integrated GFI is safer operation especially in environments presenting a shock hazard such as bathrooms. When no mains outlet comprising GFI is conveniently available, multi-socket extension cord 400 can provide GFI protection and reduce the risk of electric shock or other consequences of an electrical short.

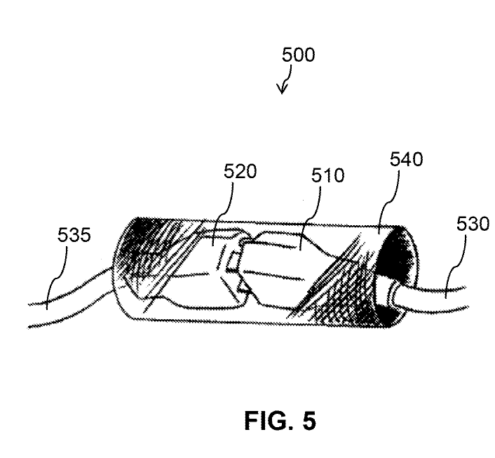

FIG. 5 is a perspective view of a mechanism 500 for securely conjoining two power cords or extension cords.

In the example shown in FIG. 5, plug 510 is at one end of a power cord connected to an electrical device (not shown in FIG. 5). A first length of power cable 530 connects plug 510 to the electrical device.

Socket 520 is at one end of an extension cord connectable to a mains supply outlet (not shown in FIG. 5). A second length of power cable 535 connects socket 520 to the mains supply outlet. The extension cord can be a multi-socket extension cord such as extension cord 400 of FIG. 4 or an extension cord with GFI such as extension cord 500 of FIG. 5.

A length of heat shrink tubing (or sleeve) 540 can be used to seal the connection between plug 510 and socket 520. Sleeve 540 can comprise mechanically expanded extruded plastic, for example, that shrinks around its diameter when heated. For the purposes of illustration, sleeve 450 is shown in FIG. 5 in its state prior to shrinking

When sleeve 540 is shrunk, it forms a seal around the connection between plug 510 and socket 520. Sleeve 540 securely fastens the power cord to the extension cord, and is not intended to be detached by the user.

In the example embodiment shown in FIG. 5, sleeve 540 can be slid over plug 510 and around cable 530 before a connection is made between plug 510 and socket 520. Once the connection is made, sleeve 540 can be slid over the connection. It is generally desirable that sleeve 540 covers both plug 510 and socket 520 in their entirety, thereby providing a secure connection and, optionally, insulation and/or waterproofing.

In other embodiments, other suitable mechanisms can be used for securely and/or permanently fastening plug 510 to socket 520.

A benefit of mechanism 500 of FIG. 5 is that a cord comprising an integrated socket box (such as socket box 140 of FIG. 1, 240 of FIG. 2, 340 of FIGS. 3 and 440 of FIG. 4) can be retrofitted to an existing power cord. The existing power cord and the cord comprising the integrated socket box can be conjoined using the mechanism shown described in FIG. 5 or another suitable mechanism. The resulting conjoined cord has the benefits of a multi-socket power cord described above.

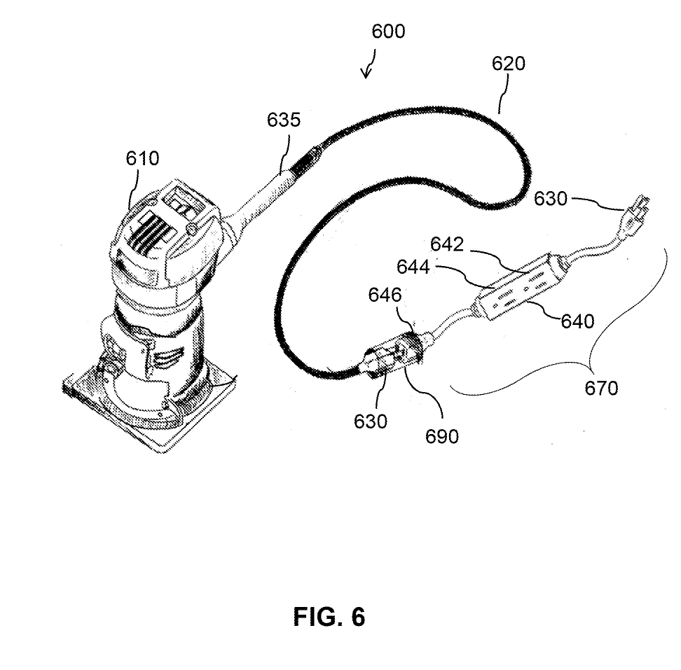

FIG. 6 is a perspective view of router 600 with an integrated multi-socket power cord 670 connected via sleeve 690. Router 600 has router tool 610, power cable 620, plug 630 and a connection 635.

In some embodiments integrated multi-socket power cord 670 is connected to plug 630 via socket 646. Plug 630 and socket 646 can be covered via sleeve 690. Integrated multi-socket power cord 670 can comprises socket box 640 with one or more sockets such as sockets 642 and 644. When plug 630 is connected to a mains power supply, sockets 642 and 644 can be used to supply power to an electrical device.

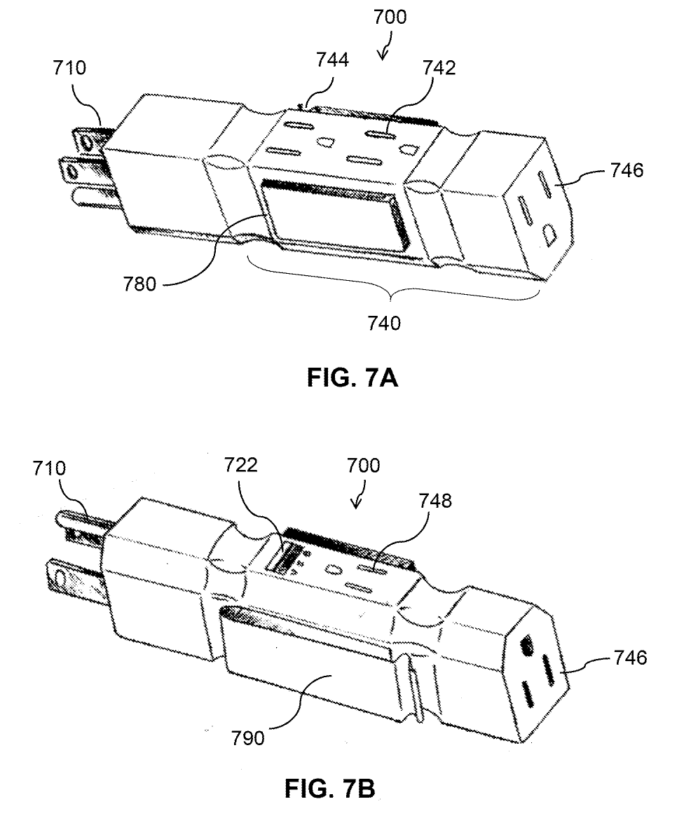

FIG. 7A is a front perspective view of multi-socket power block 700. FIG. 7B is a back perspective view of multi-socket power block 700 of FIG. 7A.

Multi-socket power block 700 has male connector (or plug) 710 and socket box 740. In some embodiments (such as that shown in FIGS. 7A and 7B) multi-socket power block 700 has no flexible cords.

Socket box 740 can have one or more sockets such as sockets 742, 744, 746, and 748 as shown in FIGS. 7A and 7B. When plug 710 is connected to a main power supply, sockets 742, 744, 746, and 748 can supply power to electrical devices.

In some embodiments, socket box 740 can include Universal Serial Bus (USB) port 722. USB port 722 allows for various electronics, such as many smartphones and tablets, to be charged and/or powered directly from multi-socket power block 700 without the need of an adapter. USB port 722 can be one of any of the several standards including, but not limited to, USB 1.x, USB 2.0, USB 3.0, and any future standards.

In some embodiments multi-socket power block 700 can include magnet 780 and/or clip 790. Magnet 780 can we used to attach multi-socket power block 700 to a magnetic surface such as a user's truck, ladder or utility belt. Similarly clip 790 can be used to attach multi-socket power block 700 to a user's truck, ladder or utility belt.

In some embodiments multi-socket power block 700 can include ground fault interrupter (GFI) (not shown).

In the embodiments described above in reference to FIG. 1 through FIG. 7B, the plug and the socket are generally of the same type of connector. Similarly, the sockets in the socket box are generally of the same type of connector as each other, and as the plug and socket at each end of the power cord or extension cord.

In other embodiments, the plug and the sockets can be different types of connectors, for example when the power cord is configured to adapt an electrical device for use in a different country than originally intended. Likewise, one or more sockets in the socket box can be different types of connector to each other, and/or to the plug or socket at each end of the power cord.

In some embodiments, a multi-socket power or extension cord, such as those described in reference to FIG. 1 through FIG. 7B, can comprise one or more switches, each switch configured to turn power on and off to a corresponding socket. A benefit of integrating switches into the power or extension cord is improved safety and the capability to operate a device independently of other devices when more than one device is connected to the cord.

In some embodiments, a multiple-socket power block or extension cord, such as those described in FIG. 1 to FIG. 7B can include a wireless router capable of acting as mobile Wi-Fi hotspot. This allows the multiple-socket power block or extension cord to be used on a worksite not just to make power more accessible, but turn a worksite into a Wi-Fi hotspot. This is useful, as construction sites often do not have access to wired internet connections. In certain embodiments a multiple-socket power block or extension cord, such as those described in FIG. 1 to FIG. 7B can include a wireless extender/booster.

The power cords and extension cords described above can be configured to accommodate a variety of electrical devices and appliances. The cord length, the number of wires, the gauge of each wire and the insulation of the outer sheath can be configured to meet the power and current requirements of electrical devices, and combinations of electrical devices, that can connect to one or more of the available sockets.

While particular elements, embodiments and applications of the present invention have been shown and described, it will be understood that the apparatus can comprise some or all of the elements, features and functionality described above.

While particular elements, embodiments and applications of the present invention have been shown and described, it will be understood, that the invention is not limited thereto since modifications can be made by those skilled in the art without departing from the scope of the present disclosure, particularly in light of the foregoing teachings.

What is claimed is:

1. A plug-in electrical device comprising:
a. a main device; and
b. a power cord, wherein said power cord comprises:
i. a plug;
ii. a socket box; and
iii. a length of electrical wire.

2. The plug-in electrical device of claim 1 wherein said main device is a power tool.

3. The plug-in electrical device of claim 1 wherein said plug is integrated into said main device.

4. The plug-in electrical device of claim 1 wherein said main device is a circular saw.

5. The plug-in electrical device of claim 1 wherein said main device is a router.

6. The plug-in electrical device of claim 1 wherein said main device is an air-compressor.

7. The plug-in electrical device of claim 1 wherein said socket box comprises a first socket.

8. The plug-in electrical device of claim 7 wherein said socket box further comprises a second socket.

9. The plug-in electrical device of claim 1 wherein said socket box is located along said length of electric wire between said main device and said plug.

10. The plug-in electrical device of claim 7 wherein said socket box comprises a ground fault interrupter.

11. A power cord comprising:
a. a plug;
b. a length of electric wire;
c. an end socket; and
d. a socket box, wherein said socket box is located along said length of electric wire between said plug and said end socket.

12. The power cord of claim 11 wherein said socket box comprises a first socket.

13. The power cord of claim 12 wherein said socket box further comprises a second socket.

14. The power cord of claim 12 wherein said socket box further comprises a ground fault interrupter.

15. The power cord of claim 11 further comprising:
e. a securing sheathe wherein said sheathe is configured to secure said end socket to a second electrical plug.

16. The power cord of claim 15 wherein said second electrical plug is connected to a power tool.

17. The power cord of claim 15 wherein said securing sheathe is a heat shrinking tubing.

18. The power cord of claim 15 wherein said securing sheathe is waterproof.

19. A power block comprising:
a. a plug;
b. a socket box comprising;
i. a first socket;
ii. a second socket; and
iii. a USB port;
c. a magnet; and
d. a clip.

20. The power cord of claim 12 wherein said socket box further comprises a ground fault interrupter.
